(19) United States
(12) Patent Application Publication
(10) Pub. No.: US 2026/0131293 A1
(43) Pub. Date: May 14, 2026

(54) MODULAR SYSTEMS AND APPARATUSES FOR CREATING FRACTURING SLURRY

(71) Applicants: Brian Blackburn, Oklahoma City, TX (US); Anna Omsberg, Bailey, CO (US)

(72) Inventors: Brian Blackburn, Oklahoma City, TX (US); Anna Omsberg, Bailey, CO (US)

(73) Assignee: SandPile Services LLC, Midland, TX (US)

(21) Appl. No.: 19/387,566

(22) Filed: Nov. 12, 2025

Related U.S. Application Data
(60) Provisional application No. 63/719,382, filed on Nov. 12, 2024.

(51) Int. Cl. B01F 23/50; B01F 23/70; B01F 35/21; B01F 35/213; B01F 35/214; B01F 35/22; B01F 35/221; B01F 35/50; B01F 35/71; B01F 35/75; B01F 101/49; E21B 43/26

(52) U.S. Cl. CPC B01F 23/59; B01F 23/565; B01F 23/708; B01F 23/713; B01F 35/21112; B01F 35/2112; B01F 35/2113; B01F 35/213; B01F 35/214; B01F 35/2203; B01F 35/2209; B01F 35/2212; B01F 35/2217; B01F 35/50; B01F 35/712; B01F 35/71705; B01F 35/71731; B01F 35/7176; B01F 35/7544; B01F 35/7547; E21B 43/2607; B01F 2101/49

(57) ABSTRACT

Modular systems and apparatuses for creating fracturing slurry disclosed in embodiments herein include, in limited part, a screening and blending tank system having a kinetic screening assembly to receive and filter unscreened sand at a first predetermined rate from a sand delivery component and water at a second predetermined rate, a debris collection component compatible with the screening assembly for removing debris and non-uniform sand particles, and an inline chemical component using a discharge pump to blend screened sand and water with a variable chemical injection without necessarily resorting to use of a blender to create a fracturing slurry that is output at a third predetermined rate for use in hydraulic fracturing operations at a wellsite. One or more sensors in communication with one or more programmable logic controllers may be used to achieve the first, second, and third predetermined rates for a desired composition of the fracturing slurry.

### CROSS REFERENCE TO RELATED APPLICATIONS

This application claims the benefit of U.S. Provisional Application No. 63/719,382, filed on Nov. 12, 2024.

### STATEMENT RE: FEDERALLY SPONSORED RESEARCH/DEVELOPMENT

Not Applicable.

### BACKGROUND OF THE INVENTION

The various aspects and embodiments described herein relate to systems and apparatuses for creating fracturing slurry used in hydraulic fracturing operations at a wellsite.

Generally, the creation of fracturing slurry for use in hydraulic fracturing operations at a wellsite involves numerous pieces of equipment taking up critical sand space on a job. One aspect of this issue relates to each piece of equipment only performing a singular task in the fracturing slurry creation process, e.g., a blender, a rock catcher, a screener, etc. Another aspect of this issue concerns the limited arrangements or configurations of the equipment needed to create fracturing slurry at a wellsite.

Additionally, exercising control over the composition of the fracturing slurry used in hydraulic fracturing operations is essential as the composition of the fracturing slurry, including, for example, the sand concentration, will need to meet the requirements of the specific job. Existing processes and apparatuses for creating fracturing slurry may only be compatible with dry frac sand or proppant which can limit their application and create silica dust exposure concerns. Other existing process and apparatuses which can utilize frac sand having a moisture content may nevertheless fail to appreciate the moisture content in creating the resulting fracturing slurry. Further, existing process and apparatuses are not self-regulating and may only achieve and then maintain control over the job-specific composition of the fracturing slurry through human intervention.

Accordingly, there is a need in the art for improved systems and apparatuses for creating fracturing slurry used in hydraulic fracturing operations at a wellsite.

### SUMMARY OF THE INVENTION

Some embodiments provided herein are described by way of the following provided embodiments and also provided as possible combinations or overlapping embodiments.

Some embodiments disclosed herein relate to a modular system for creating fracturing slurry. In some embodiments, the modular system may have a sand delivery component to deliver sand at a first predetermined rate to a screening and blending tank system. In some embodiments, the sand delivery component may include a feed hopper and a conveyor belt assembly configured to meter sand for delivery at the first predetermined rate. The screening and blending tank system may have a tank which may be configured to receive sand into an intake chamber located inside the tank and receive water at a second predetermined rate through an intake opening in the tank using an intake pump. The screening and blending tank systems may also filter sand and water through a kinetic screening assembly located inside the tank and fluidly connected to the intake chamber, wherein the screening assembly comprises at least one screen having a plurality of perforations of a predetermined size to separate out debris and oversized particles. The tank system may further clean debris and oversized particles from the kinetic screening assembly into a debris collection component operatively connected to the screening assembly using a spray component disposed above the kinetic screening assembly, wherein the debris collection component comprises a collection tray coupled to a sloped channel having an outlet that exits the tank for discharge of debris and oversized particles. The tank system may also receive a mixture of filtered sand and water from the kinetic screening assembly into a unit chamber within the tank. The unit chamber may have at least one discharge opening to dispense the sand and water mixture. In some embodiments, the unit chamber may maintain a desired level of the sand and water mixture. The sand and water mixture may be transported along an inline blending component using at least one discharge pump fluidly connected to the discharge opening to receive a variable chemical input, wherein the sand and water mixture blends with the variable chemical input to produce a fracturing slurry. Output of the fracturing slurry for use in hydraulic fracturing operations may occur at a third predetermined rate maintained by the at least one discharge pump.

In certain embodiments, the tank may comprise an open-top rectangular tank having a rounded bottom. In other embodiments, the intake opening may be located near a bottom of the tank. The intake chamber may also include a partition configured to direct sand from the sand delivery component into contact with water from the intake opening. In certain embodiments, the kinetic screening assembly may comprise a vibrating shaker screen deck disposed above a waterline and positioned at an incline. In yet other embodiments, the spray component may comprise a spray bar having a plurality of perforations or orifices configured to disperse pressurized fluids across a width of the screen. In additional embodiments, the debris collection component may comprise a screen as a bottom of the sloped channel to drain captured liquid back into the unit chamber. In some embodiments, a check valve may be operatively connected to the discharge opening to prevent flowback toward the unit chamber. In alternative embodiments, the inline blending component may comprise a pipe section positioned between the discharge opening and the at least one discharge pump, the pipe section comprising threaded or flanged ports. In further embodiments, the one or more discharge pumps may comprise two discharge pumps for split stream operations.

In some embodiments described herein, a modular apparatus for creating fracturing slurry is disclosed. The modular apparatus may have a tank which may receive sand into an intake chamber at a first predetermined rate. An intake pump fluidly may connect to the tank though an intake opening, wherein the intake pump may be configured to control a flow of water through said opening into the tank at a second predetermined rate. A kinetic screening assembly located within the tank and fluidly connected to the intake chamber may have a screen having a plurality of perforations of a predetermined size to separate out debris and oversized particles. The kinetic screening assembly may filter sand from the intake chamber. A spray component may be disposed above the kinetic screening assembly to clean debris and oversized particles from said screening assembly. A debris collection component may be operatively connected to the screening assembly. The debris collection component may have a collection tray coupled to a sloped channel with an outlet that exits the tank for discharge of debris and oversized particles. Within the tank, there may be a unit chamber which may have at least one discharge opening to dispense a mixture of filtered sand and water received from the kinetic screening assembly. An inline blending component may be fluidly connected to the discharge opening and at least one discharge pump. With respect to the inline blending component, there may be one or more inlets to inject a variable chemical input into the sand and water mixture, wherein the sand and water mixture blends with the variable chemical input to produce a fracturing slurry. The discharge pump may output the fracturing slurry at a third predetermined rate.

In other embodiments, the tank may comprise a liner to prevent corrosiveness of produced water. The kinetic screening assembly may also comprise an oval tumbling screen. In further embodiments, the spray component may comprise one or more spray head nozzles having defined spray patterns. In certain embodiments, the debris collection component may comprise the collection tray operatively mounted within the screening assembly at an apex of rotation and wherein the screen may comprise one or more ledges or flights affixed to an inner surface configured to lift debris and oversized particles. In yet other embodiments, the outlet may be configured to direct debris and oversized particles to a container coupled to the tank. In additional embodiments, the inline blending component may comprise a pipe joint having one or more inlets that are two inches in length for direct injection of the variable chemical input. In some embodiments, the modular apparatus may be mounted on a skid, truck, or trailer. In other embodiments, two discharge pumps may be utilized to support split-stream hydraulic fracturing operations. In yet further embodiments, one or more sensors may transmit real-time information to a programmable logic controller (PLC), which may regulate the first, second, and third predetermined rates to maintain a desired composition of fracturing slurry.

Some embodiments disclosed herein relate to a modular system of creating fracturing slurry. In some embodiments, the modular system may have a sand delivery component to deliver sand at a first predetermined rate to a screening and blending tank system. The sand delivery component may achieve the first predetermined rate in response to one or more signals from at least one PLC in communication with a plurality of sensors. The screening and blending tank system may have a tank which may receive sand into an intake chamber located inside the tank and receive water at a second predetermined rate through an intake opening in the tank using an intake pump. The intake pump may achieve the second predetermined rate in response to one or more signals from the PLC in communication with the plurality of sensors. The tank system may also filter sand and water through a kinetic screening assembly located inside the tank and fluidly connected to the intake chamber.

The screening assembly may have at least one screen having a plurality of perforations of a predetermined size to separate out debris and oversized particles. The screening assembly may further clean debris and oversized particles from the kinetic screening assembly into a debris collection component operatively connected to the screening assembly using a spray component disposed above the kinetic screening assembly. The debris collection component may have a collection tray coupled to a sloped channel having an outlet that exits the tank for discharge of debris and oversized particles. The tank system receives a mixture of filtered sand and water from the kinetic screening assembly into a unit chamber within the tank. The unit chamber may have at least one discharge opening to dispense the sand and water mixture. The sand and water mixture may be transported along an inline blending component using at least one discharge pump fluidly connected to the discharge opening to receive a variable chemical input. The sand and water mixture may blend with the variable chemical input to produce a desired composition of fracturing slurry. Output of the fracturing slurry for use in hydraulic fracturing operations may occur at a third predetermined rate maintained by the at least one discharge pump. The discharge pump may achieve the third predetermined rate in response to one or more signals from the PLC in communication with the plurality of sensors. In certain embodiments, the PLC may comprise a data van or control station.

In some embodiments, the plurality of sensors may comprise a volumetric sensor positioned at the sand delivery component. The plurality of sensors may also comprise a moisture sensor configured to measure a moisture content of sand delivered to the intake chamber. In other embodiments, the plurality of sensors may comprise a flow meter positioned in line with the intake pump to monitor a flow rate of water. In yet further embodiments, the plurality of sensors may comprise a sonic water level sensor positioned on the tank to measure a water level of the unit chamber. In certain embodiments, the plurality of sensors may comprise one or more pressure transducers positioned at the at least one discharge pump to measure a pressure of the fracturing slurry. In certain embodiments, the PLC may transmit commands to a motor operatively connected to a strike-off plate to regulate a volume of sand delivered to the intake chamber. In further embodiments, the PLC may transmit commands to a motor for a head pulley shaft configured to control sand speed for the sand delivery component according to further embodiments. Some embodiments may incorporate a data van which may display real-time information received by the PLC, including sand speed, sand concentration, clean rate, and slurry pressure.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a perspective view of an embodiment of the modular system and apparatus for creating fracturing slurry at a wellsite.

FIG. 2 illustrates a side-sectional view of an embodiment of the sand delivery component on an embodiment of a modular system and apparatus for creating fracturing slurry at a wellsite.

FIG. 3 illustrates a cross-sectional view of an embodiment of the intake chamber in a modular system and apparatus for creating fracturing slurry at a wellsite.

FIG. 4 illustrates a perspective view of an embodiment of the screening and blending tank system in a modular system and apparatus for creating fracturing slurry at a wellsite.

FIG. 5 illustrates a side-sectional view of an embodiment of the modular apparatus for creating fracturing slurry at a wellsite.

FIG. 6A illustrates a side-sectional view of an embodiment of the screening and blending tank in a modular system and apparatus for creating fracturing slurry at a wellsite.

FIG. 6B illustrates a side-sectional view of an embodiment of the screening and blending tank in a modular system and apparatus for creating fracturing slurry at a wellsite.

FIG. 7 illustrates a plan view of an embodiment of the screening and blending tank in a modular system and apparatus for creating fracturing slurry at a wellsite.

FIG. 8 illustrates a cross-sectional view of an embodiment of the screening and blending tank in a modular system and apparatus for creating fracturing slurry at a wellsite.

FIG. 9 illustrates a side-sectional view of an embodiment of an inline blending component in a modular system and apparatus for creating fracturing slurry at a wellsite.

FIG. 10 illustrates a diagram of a plan view of an embodiment of a modular system for creating fracturing slurry using a plurality of sensors in communication with at least one programmable logic controller (PLC).

FIG. 11 illustrates a side-sectional view of an embodiment of a modular system and apparatus for creating fracturing slurry at a wellsite.

FIG. 12 illustrates a plan view of an embodiment of a modular system and apparatus for creating fracturing slurry at a wellsite.

### DETAILED DESCRIPTION

The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of configurations, all of which are explicitly contemplated herein.

All technical terminology included herein retains the definitions typically understood by an individual skilled in the relevant field of technology. The definition of some terms and expressions used is nevertheless provided below. The terminology used herein is for the purpose of describing particular embodiments only and is not intended to be limiting. It should be noted that, the singular forms “a”, “an”, and “the” include plural forms as well, unless the content clearly dictates otherwise. It should also be noted that the term “or” is generally employed in its sense including “and/or” unless the context clearly dictates otherwise. Furthermore, to the extent that the terms “including,” “includes,” “having,” “has,” “with,” or variants thereof are used in the detailed description, such terms are intended to be inclusive in a manner similar to the term “comprising.”

The term “fracturing slurry,” as used herein, encompasses a composition of proppant and fluids injected into a wellbore for use in hydraulic fracturing operations. By way of example, and without limitation, the composition may include water, screened sand, and a variable chemical input.

The term “rate monitoring point,” as used herein, encompasses one or more locations along the disclosed embodiments where substances, such as sand, water, or fracturing slurry, may be in motion or under pressure and such motion or pressure may be measured. By way of example, and without limitation, some embodiments of flow monitoring points may include a bottom side of a conveyor belt or an inside of a feed hopper of a sand delivery component, an intake opening on a tank, and above a mixture of filtered sand and water in a unit chamber of the tank.

The term “real-time information,” as used herein, encompasses information or data observed through one or more sensors positioned on one or more rate monitoring points and communicated to a programmable logic controller (PLC) at a same rate at which information is observed. By way of example, and without limitation, the real-time information may include a flow rate of water being pumped into the intake chamber, a moisture level of sand being delivered to the intake chamber, and a pressure, measured in pounds per square inch (psi), of the fracturing slurry.

The term “rate control component,” as used herein, encompasses one or more controllable elements of the disclosed embodiments which may be configured to, without limitation, adjust mass, volumetric flow, or pressure of substances, such as sand, water, or fracturing slurry. By way of example, and without limitation, some embodiments of the rate control components may include one or more motors for one or more intake pumps, one or more discharge pumps, a strike-off plate, or a head pulley shaft of the conveyor belt.

The various example embodiments disclosed herein are directed to modular systems and apparatuses which produce a fracturing slurry that may be directly injected into a wellbore. In some embodiments, one or more sensors in communication with one or more PLCs may be utilized to achieve a desired composition of the fracturing slurry.

According to the illustrative embodiments disclosed herein, fracturing slurry may be created utilizing unprocessed sand that may be wet or dry. As explained in an embodiment below, sand comprising a moisture percentage may be delivered to a sand delivery component where the moisture percentage may be identified, utilizing a plurality of sensors in communication with a PLC, and accounted for to maintain a desired composition of fracturing slurry.

Another beneficial aspect of the disclosed embodiments may be the reduction of the environmental footprint due to the incorporation of three key pieces of equipment used in hydraulic fracturing operations: a rock catcher, a blending unit or truck, and a sand belt. A kinetic screening assembly may screen unprocessed sand for debris and non-uniform sand particles prior to blending. Debris and non-uniform sand particles may be captured and forced into a debris collection component for disposal using a spray component disposed above the kinetic screening assembly. Using one or more discharge pumps, screened sand and water may be pumped out of one or more discharge openings through a pipe joint and may receive a variable chemical input through one or more inlets in the pipe joint. Screened sand, water, and the variable input may become blended along an inline blending component through turbulence that may be created from the one or more discharge pumps. According to some embodiments, the inline blending component may cause blending of screened sand, water, and the variable chemical input without a blender, such as a frac blending truck or a separate piece of blending equipment, that is typically used in hydraulic fracturing operations.

To decrease non-productive time, or non-pumping time, at a wellsite, the embodiments disclosed herein may be modular—that is, the disclosed embodiments reflect standardized units, dimensions, and sequences used in hydraulic fracturing operations—to allow for greater ease and efficiency in switching out or replacing components or equipment. As the disclosed embodiments illustrate, there may be numerous configurations of components and systems for producing fracturing slurry to minimize the spatial footprint of fracturing slurry-producing equipment and to adapt to job needs at the wellsite. In addition to the modular benefits, some embodiments may be mounted on a skid, truck, or trailer for increased portability to the wellsite.

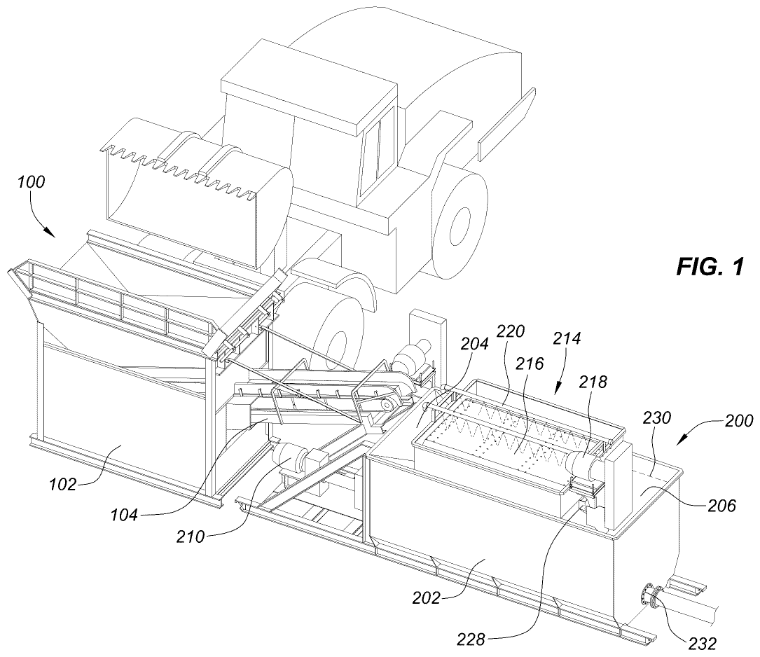

To produce the fracturing slurry, sand or proppant used in hydraulic fracturing operations may be transported to the sand delivery component. Sand may be transported to the wellsite from a quarry or mine using any conventional sand transportation method such as a dump truck. Sand may be screened or unscreened. As expressed above, sand may be dry or wet prior to transportation to the sand delivery component. According to some embodiments, FIG. 1 demonstrates that a front-end loader may be used to deliver sand to the sand delivery component 100, but there may be other ways to deliver sand, such as, by way of a series of conveyor belt systems transporting sand from silos located at the wellsite.

FIG. 1 illustrates an embodiment of the sand delivery component 100 receiving sand used in hydraulic fracturing operations. It is contemplated that there are numerous embodiments known in the art which may be employed as a sand delivery component 100. In some embodiments, as illustrated in FIGS. 1-4, the sand delivery component may include a feed hopper 102 with a conveyor belt 104. An alternative embodiment of the sand delivery component 100 may include one or more conveyor belts 104 connected to a sand storage unit that feeds directly into an intake chamber 204 of a tank 202. Further embodiments may include a sand box system disposed above one or more conveyor belts 104 which delivers sand into a metering hopper.

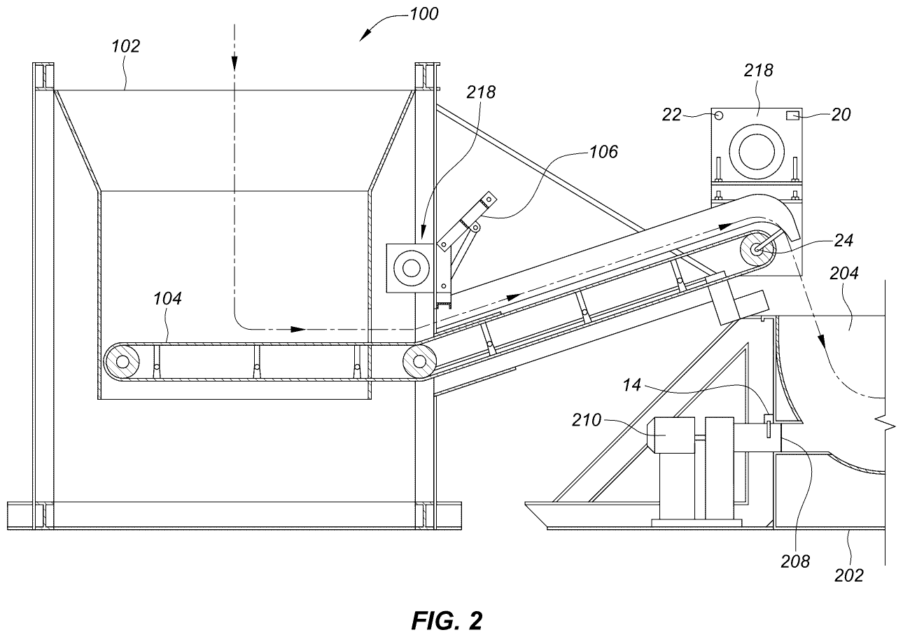

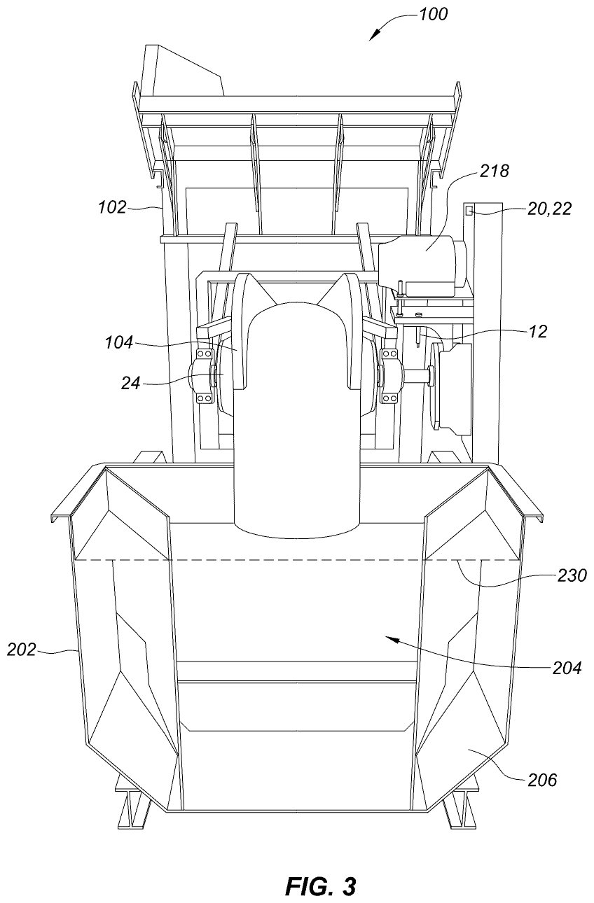

According to the embodiment illustrated in FIG. 2, sand in the feed hopper 102 may be funneled onto the conveyor belt 104 which may operate at a fixed speed, thereby metering the sand for delivery to the intake chamber 204 of the tank 202 at a first predetermined rate. In some embodiments, the first predetermined rate may comprise a dry sand weight concentration (or density), volume of dry sand in the fracturing slurry, in pounds per gallon (ppg). At least one sensor in communication with at least one PLC may meter sand to the intake chamber 204 to maintain the first predetermined rate. Some examples of the types of sensors that may be utilized, as represented in FIGS. 2-3, may include, without limitation: a volumetric sensor 20 such as a laser scanner, to measure a dimension or volume of sand in pounds per minute (lbs/min.) as it is delivered to the intake chamber 204; a moisture sensor 22 such as a touchless infrared moisture sensor, to measure the moisture content of sand (i.e., percentage of water in sand); a proximity switch 12, to measure a rotational speed in rotations per minute (rpm) of a head pulley shaft 24 on the conveyor belt 104; or a weight or belt scale, to measure the weight of sand being delivered to the intake chamber 204.

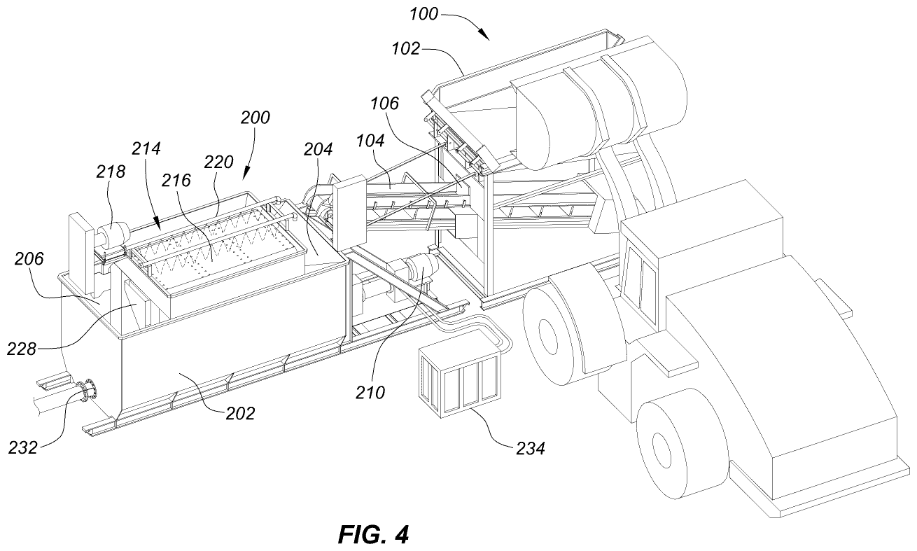

In the illustrated embodiments of FIGS. 2-4, the feed hopper 102 may include a strike-off plate 106, or a flat plate, mounted on the feed hopper 102 over the conveyor belt 104. A motor 218 operatively connected to the strike-off plate 106 may regulate the volume of sand exiting the feed hopper 102 from the belt 104 by raising or lowering the plate 106. In some embodiments, a laser sensor may be positioned on the sand delivery component 100 to measure a height of the plate 106 and corresponding sand bed on the conveyor belt 104 to account for and control the dimension of sand delivered to the intake chamber 204. FIGS. 1 and 4 illustrate that sand from the delivery component 100 may be delivered to a screening and blending tank system 200 for processing into fracturing slurry. The screening and blending tank system 200 may include the tank 202. As illustrated in FIGS. 1 and 4, the tank 202 may comprise an open-top tank in the shape of a rectangle. It will be appreciated that there are alternative embodiments for the tank 202, including, without limitation, a partially covered tank or a square-shaped tank. The tank 202 may be rounded on a bottom to prevent settling of sand and water and uneven turbulence. As shown in FIG. 3, the tank 202 may comprise two chambers: the intake chamber 204 and a unit chamber 206. However, it is contemplated that other embodiments may include more than two chambers, e.g., a discharge chamber. In yet other embodiments, the intake chamber 204 may include a partition that directs incoming sand into contact with incoming water from the intake opening 208, promoting initial mixing.

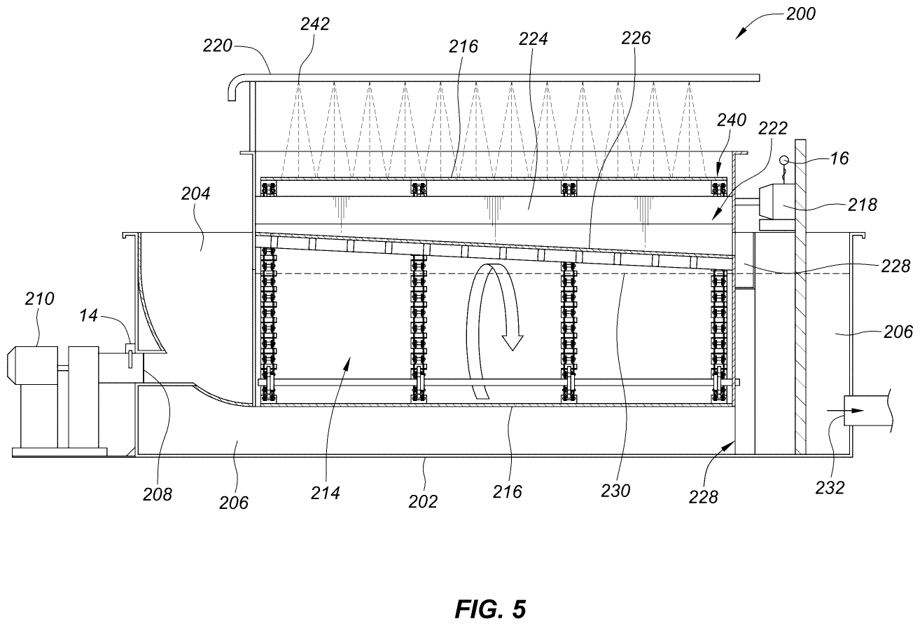

FIG. 3 illustrates the conveyor belt 104 of the sand delivery component 100 positioned above the tank 202 to deliver sand into the intake chamber 204. As illustrated in FIG. 4, the tank 202 may further comprise an intake opening 208 to receive water at a second predetermined rate. The second predetermined rate may be maintained and controlled by one or more intake pumps 210, as represented in FIG. 4. In some embodiments, the second predetermined rate may comprise a clean rate, or a flow rate of fluids being pumped before sand or proppant may be added, in barrels per minute (bpm). As illustrated in FIG. 5, some embodiments may further comprise at least one sensor in communication with at least one PLC to increase or decrease a flow of water to the intake chamber 204 to maintain the second predetermined rate. Some examples of the types of sensors that may be utilized include, without limitation: a sonic water level sensor 16, to equalize water intake and output between the intake pump 210 and at least one discharge pump 212; or a flow meter 14, to monitor a flow rate of water.

As illustrated by the embodiment of FIGS. 1-2 and 4, the intake pump 210 may comprise a conventional pump used in hydraulic fracturing operations which may be powered by a variety of sources, e.g., electricity, diesel, etc. In one embodiment, the intake pump 210 may be coupled to the tank 202 or positioned on a skid unit that is separate from the tank 202. The intake opening 208 may be connected to the intake pump 210 through a conduit, such as a pipe, tube, or inlet. Water received by the intake chamber 204 may be stored in a fluid storage container 234, like a frac tank or other commercially available fluid storage container, that may be located onsite. In some embodiments, as exemplified in FIG. 4, the intake pump 210 may be connected to the frac tank 234 to provide water to the tank 202. Some hydraulic fracturing operations may use produced water which can more quickly decrease the lifespan of various pieces of equipment. In some embodiments, the tank 202 may incorporate a liner to prevent corrosiveness of produced water. In yet other embodiments, the tank 202 may comprise durable materials which are resistant to corrosion, including non-metal materials. It is contemplated that the tank 202 may comprise materials which are designed to be disposable or consumable.

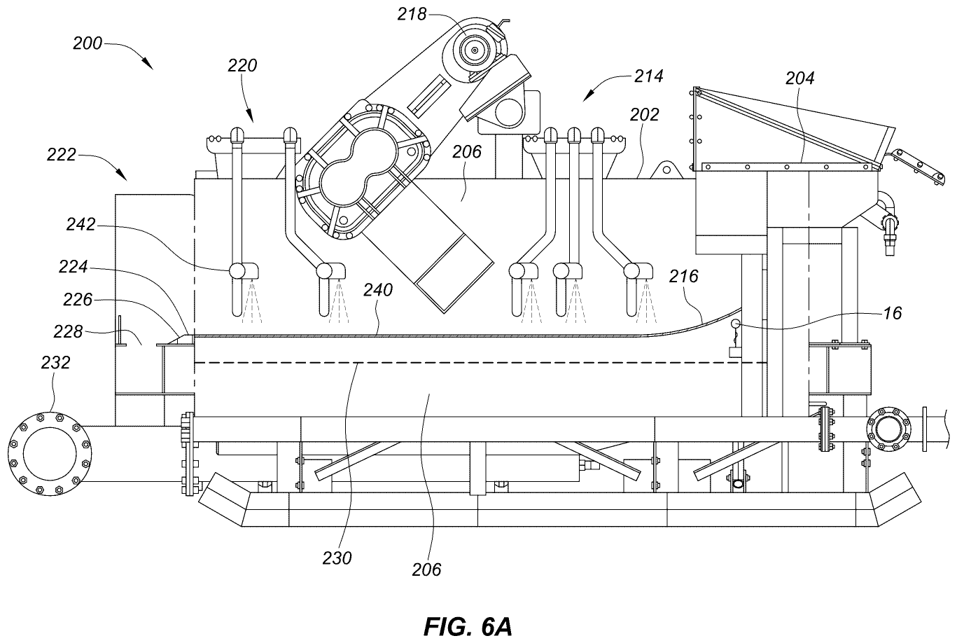

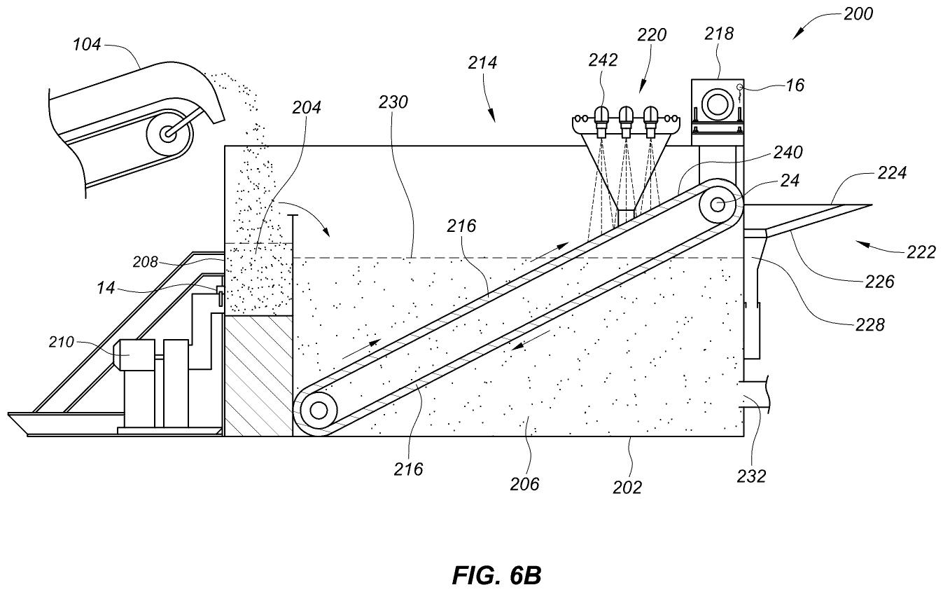

In some embodiments, water may be pumped through the intake opening 208 located near the bottom of the tank 202 to avoid interference with sand being delivered to the intake chamber 204 from above. As exemplified in FIGS. 2 and 5, in other embodiments, the intake opening 208 may be positioned in the intake chamber 204 to facilitate filtration of unscreened sand. Once received, sand and water may flow to the kinetic screening assembly 214 for filtration. In some embodiments, the intake chamber 204 may be configured to restrict egress of received sand and water to other areas of the unit chamber 206 to prevent contamination of filtered sand and water. As shown in FIG. 3, the intake chamber 204 may be formed internally within the tank 202. Certain embodiments of the intake chamber 204 may include baffles to attenuate turbulence and mitigate re-entrainment of debris. FIG. 5 illustrates that some embodiments of the intake chamber 204 may be in fluid communication with the kinetic screening assembly 214.The unit chamber 206 may comprise a main body of the tank 202 where a mixture of filtered sand and water collect after passing through the screening assembly 214. The unit chamber 206 may further comprise the kinetic screening assembly 214 where portions of the screening assembly 214 may be positioned below the waterline 230 as the mixture of filtered sand and water accumulate in the unit chamber 206, as illustrated in FIGS. 5 and 6B.

The unit chamber 206 may comprise a main body of the tank 202 where a mixture of filtered sand and water collect after passing through the screening assembly 214. The unit chamber 206 may further comprise the kinetic screening assembly 214 where portions of the screening assembly 214 may be positioned below the waterline 230 as the mixture of filtered sand and water accumulate in the unit chamber 206.

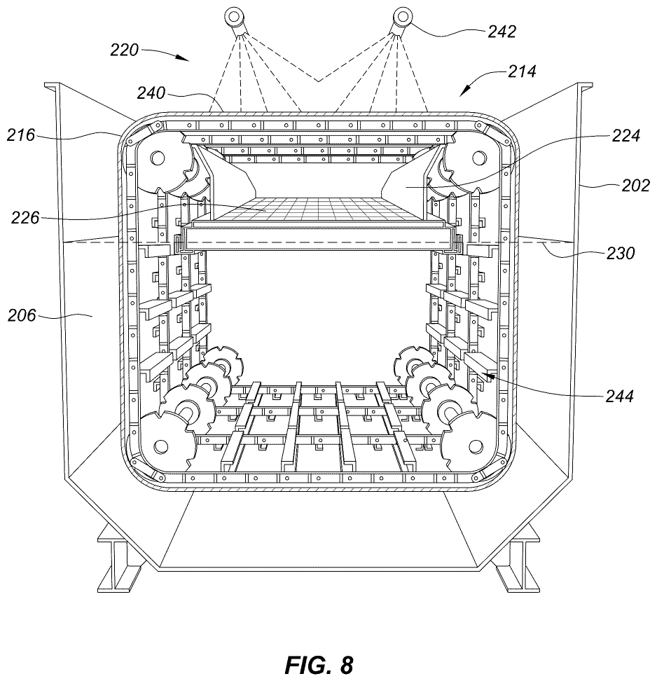

In various embodiments, as illustrated in FIGS. 1, 4-8 the kinetic screening assembly 214 may comprise at least one screen having a plurality of perforations 216 of a predetermined size which may be connected to a frame or body capable of movement to filter sand from the intake chamber 204 and water from the tank 202. Movement of the kinetic screening assembly 214 may be accomplished through one or more motors 218 affixed to the assembly, for example. The screen 216 may comprise any material suitable for filtering sand and water in hydraulic fracturing operations, such as wire mesh, stainless steel, plastic, or polyurethane. In further embodiments, as shown in FIGS. 5-6B, the screen 216 may include one screen 216 or two or more screens 216 connected to one another to form a larger screen 216. In some embodiments, the screening assembly 214 may be partially submerged in water to facilitate filtering of sand through perforations in the screen 216. In the embodiment illustrated in FIGS. 5 and 8, the kinetic screening assembly 214 may comprise a tumbling screen 216 where sand and water pass-through the perforations into the unit chamber 206 as the screen 216 rotates.

In some embodiments of the screening assembly 214 as illustrated in FIG. 6A, unscreened sand and water may be received into the intake chamber 204 and flow over one or more ledges or baffles 244 operatively connected to the chamber 204 and onto a vibratory shaker screen 216 deck or surface 240 disposed above a waterline 230 of the unit chamber 206. In certain embodiments, the screen 216 may be positioned at an incline, which may be between 15-25 degrees in certain embodiments, with the highest point of incline on an intake side of the unit chamber 206. The screen deck 240 vibrates using one or more motors 218 to promote passage of sand and water through the perforations in the screen 216 into the unit chamber 206 while conveying debris and oversized particles to a discharge end of the screen 216 for disposal.

In some embodiments, the shaker screen 216 may be operatively positioned on various springs which may be mounted to the tank 202 to provide suspension of the screen 216 in the unit chamber 206. Beneath the shaker screen 216, screened sand and water exit the unit chamber 206 though at least one discharge opening 232. In some embodiments, the screening assembly 214 incorporating the vibratory shaker screen 216 may be more compact in size (approx. twenty (20) feet) compared to conventional vibratory shaker screening assemblies (approx. forty (40) feet or more), thereby taking up less space on the wellsite. In further embodiments, to mitigate safety risks and transportation issues, the screening assembly 214 incorporating the vibratory shaker screen 216 may be operated on the ground without needing additional suspension as may be required by conventional vibratory shaker screening assemblies (approx. twenty (20) feet off of the ground).

FIG. 6B demonstrates that in other embodiments, the screening assembly 214 may comprise a belt screen 216 affixed to at least two pulleys with one or more motors 218 configured to rotate like the conveyor belt 104. A top side of the screen 216 and a bottom side of the screen 216 may cooperate to pass sand and water through perforations into the unit chamber 206 as the screen 216 rotates. In various embodiments, sizes of perforations for the screen 216 may be selected to retain oversized particles while permitting uniform sand particles to pass through. In certain embodiments, screens 216 having varied perforation sizes may be used to suit specific job requirements. As sand and water filter through perforations in the screen 216, debris and oversized particles unable to pass through may accumulate on the side of the screening assembly 214.

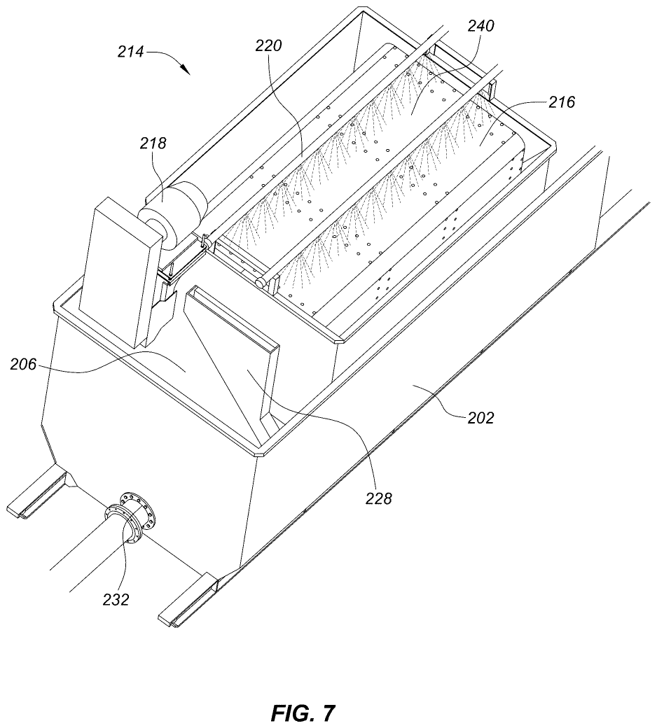

Accumulating debris and oversized particles may obstruct perforations in the screen 216 and limit perforations through which uniform sand particles may flow, thereby impacting sand concentration for the screened sand and water mixture in the unit chamber 206. According to various embodiments and as illustrated in FIGS. 1, 4-8, the spray component 220 may be disposed above the screening assembly 214 to direct pressurized water or other fluids across a screen surface 240 to clean accumulating debris and oversized particles from the screening assembly 214 into the debris collection component 222. In the embodiment illustrated in FIGS. 5 and 7, the spray component 220 may include a spray bar comprising a pipe or tubular member having a plurality of perforations or orifices capable of dispersing pressurized fluids across the width of the screen 216.

In other embodiments, the spray component 220 may include one or more spray head nozzles or spouts 242 affixed to a bar, tube, or pipe with the one or more nozzles 242 having defined spray patterns to achieve uniform coverage of the screen surface 240, as illustrated in FIGS. 5-8. Fluids utilized by the spray component 220 may be supplied from the fluid storage container 234 or a separate utility line. In some embodiments, spray pressure or flow may be controlled through commands transmitted by the PLC to the corresponding rate control component, such as a control valve, to optimize cleaning of the screen surface 240 without impeding sand passage through the screen 216.

As illustrated in FIGS. 5-6B, the debris collection component 222 may be operatively connected to the screening assembly 214 and comprise a collection tray 224 coupled to a sloped channel 226 extending to an outlet 228 to discharge accumulating debris and oversized particles. In some embodiments, the sloped channel 226 may comprise a funnel. To minimize water loss, FIGS. 7-8 illustrates that some embodiments may incorporate a screen 216 as a bottom of the channel 226 as part of the collection tray 224 to drain any captured liquid back into the unit chamber 206. In some embodiments, as shown in FIGS. 5-7, the outlet 228 may be configured to direct debris and oversized particles for disposal external to the tank 202. In other embodiments, the outlet 228 may direct debris and oversized particles to a container which may be coupled to the tank 202 for accumulation and later disposal. As will be appreciated by the embodiments illustrated in FIGS. 5-8, the debris collection component 222 may be configured to adapt to the selected embodiment of the screening assembly 214 to facilitate collection and disposal of debris and particles.

For example, in the embodiment of FIG. 8, the collection tray 224 may be operatively mounted within the screening assembly 214 at a position corresponding to an apex of the screen's 216 rotation to collect debris and oversized particles, including those dislodged by the spray component 220. In some embodiments, the screen 216 may comprise one or more ledges 244 (or flights or baffles) affixed to an inner surface of the screen 216 configured to lift accumulating debris and oversized particles as the screen 216 rotates. Debris and particles may fall into the collection tray 224 as the screen 216 completes a full rotation. As illustrated in FIG. 5, the tray 224 may discharge into the sloped channel 226 which conveys debris and oversized particles to the outlet 228 that exits the tank 202.

In other embodiments, including the embodiment illustrated in FIG. 6A, the collection tray 224 of the debris collection component 222 may be mounted or coupled to the discharge end of the screen 216 to capture debris and oversized particles conveyed down the incline of the screening assembly 214 by vibration and facilitated by the spray component 220. As illustrated in FIG. 6A, the spray nozzles 242 may be incorporated into evenly-spaced spray bars positioned across the screen 216 to achieve comprehensive coverage of spray on the screen surface 240 to remove debris. Consistent with other embodiments, the collection tray 224 may discharge into the sloped channel 226 with the outlet 228 exiting the tank 202. In yet further embodiments as shown in FIG. 6B, the collection tray 224 may be operatively positioned below the belt screen 216 and spray component 220 at the discharge end of the tank 202 to receive debris and oversized particles cleaned from the screen surface 240. As described in other embodiments, the tray 224 may be connected to the sloped channel 226 and convey debris to the outlet 228 to exit the tank 202.

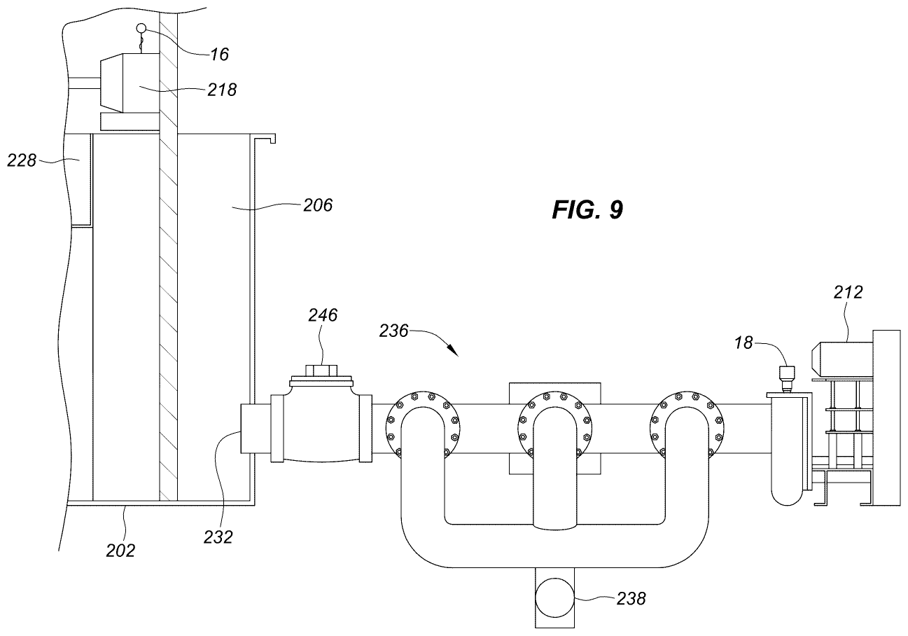

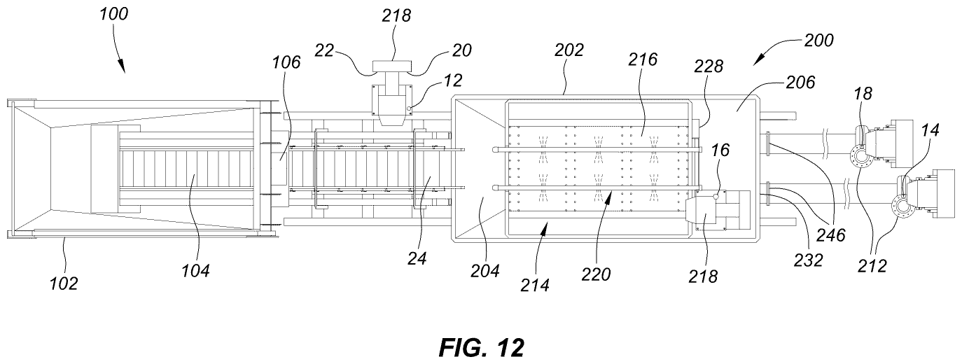

As shown in FIGS. 1, 4-7, 9, the unit chamber 206 comprises at least one discharge opening 232 fluidly connected to the at least one discharge pump 212 for dispensation of the mixture. As will be appreciated by the embodiment shown in FIG. 12, it is contemplated that more than one discharge pumps 212 may be utilized, for example, in split stream hydraulic fracturing operations. In the illustrated embodiment of FIG. 9, the discharge pump 212 may transport the screened sand and water mixture from the discharge opening 232 along an inline blending component 236, such as a port or manifold, to receive a variable chemical input 238. In some embodiments, as illustrated in FIG. 9, the inline blending component 236 may comprise a pipe section positioned between the discharge opening 232 and the discharge pump 212 and fluidly connected to both. The pipe section may be a short spool (for example, on the order of three feet) with threaded or flanged ports. In other embodiments, the pipe section may be positioned between the discharge pump 212 and a downstream manifold.

A pipe joint comprising one or more inlets, which may be two inches in length in some embodiments, for direct injection of the variable chemical input 238 may further be incorporated into the inline blending component 236. The chemical input 238 may include conventional chemical additives used to create the fracturing slurry, such as friction reducers and biocide surfactants. Though, it is contemplated that nonconventional chemical additives may also be used. In the embodiment of FIG. 9, turbulence and high-velocity flow generated by the discharge pump 212 blends the mixture with the variable chemical input 238 prior to passing through the discharge pump 212 thereby producing the fracturing slurry used in hydraulic fracturing operations. To prevent flowback of the mixture towards the unit chamber 206, a check valve 246 may be operatively connected to the discharge opening 232. In yet other embodiments, blending of the mixture and the variable chemical input 238 may also occur after passing through the discharge pump 212, as some chemical additives may require shear for processing.

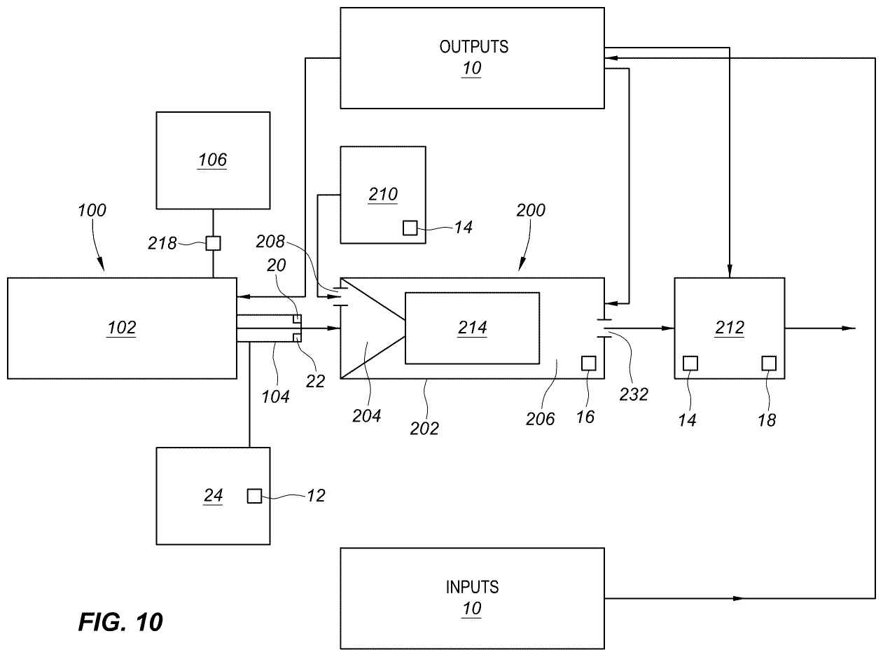

As illustrated in the embodiment of FIG. 9, the discharge pump 212 may output the fracturing slurry at a third predetermined rate for injection into a wellbore. In some embodiments, the third predetermined rate may comprise a pressure of the fracturing slurry, measured in pounds per square inch (psi), being pumped into the wellbore. Some embodiments may further comprise at least one sensor in communication with at least one PLC to increase or decrease a flow of fracturing slurry to the wellbore to maintain the third predetermined rate. According to various embodiments, FIGS. 10-12 illustrate some examples of the types of sensors that may be utilized which include, without limitation: a pressure transducer 18, to measure the pressure (psi) of the fracturing slurry flowing from the discharge pump 212; the sonic water level sensor 16, to equalize water intake and output between the intake pump 210 and the discharge pump 212; or the flow meter 14, to monitor a flow rate of the fracturing slurry. In some embodiments, the fracturing slurry may be injected into the wellbore utilizing one or more frac pumps. Other embodiments may incorporate a plurality of discharge pumps 212 for pumping fracturing slurry to a plurality of frac pumps to meet the needs of the hydraulic fracturing operation.

To produce the desired composition of fracturing slurry, some embodiments may incorporate a plurality of sensors in communication with one or more PLCs. As FIGS. 10-12 the plurality of sensors may be positioned at various rate monitoring points to communicate real-time information to the PLC. It is contemplated that the PLC may also transmit one or more commands from the control station or data van 10 which may be located at the wellsite or at a remote distance from the wellsite, as indicated by FIG. 10. In some embodiments, the data van 10 may further house operator interfaces (or human-machine interfaces), control logic software to display real-time information collected by PLCs, and communication systems. The data van 10 may display real-time information, including, in some embodiments, related to sand speed (lbs/min.), clean rate (bpm), sand concentration (ppg), flow rate (bpm), slurry rate (bpm), slurry pressure (psi), and chemical injection rates. The PLC may comprise one or more programs which may apply logic, or a set of systematic procedures to solve specific problems, to said information received from the sensors. The PLC may then transmit the commands to be executed by one or more rate control components to achieve the first predetermined rate, the second predetermined rate, and the third predetermined rate, thereby producing the desired composition of fracturing slurry.

In some embodiments, the first predetermined rate may comprise the dry sand weight concentration (ppg). To produce a desired composition of fracturing slurry according to certain embodiments, the dry sand weight concentration (ppg) may be achieved and maintained utilizing one or more of the plurality of sensors in communication with the PLC. As illustrated in FIGS. 10-12, the volumetric sensor 20 may be positioned on or adjacent to one or more rate monitoring points on the sand delivery component 100, such as the hopper 102 or conveyor belt 104, to measure the volume of sand (lbs/min), delivered to the intake chamber 204 of the screening and blending tank system 200. The moisture sensor 22 may further measure the moisture content of sand delivered to the intake chamber 204 through the intake opening 208.

In some embodiments, including as illustrated in FIGS. 3, 10 and 12, the proximity switch 12 mounted adjacent a head pulley shaft 24 measures the rotational speed of the shaft 24, in rotations per minute (rpm), of the sand delivery component 100 for communication to the PLC. In yet other embodiments, a weight or belt scale may be incorporated under the conveyor belt 104 to measure the weight of sand (lbs.) on the belt 104. As represented in FIG. 10, the sensors 20, 22 may communicate the real-time information to the PLC which may calculate the dry sand weight concentration (ppg) of sand delivered to the intake chamber 204. The PLC may receive the real-time information from the plurality of sensors and may responsively transmit commands to the rate control components to maintain the first predetermined rate.

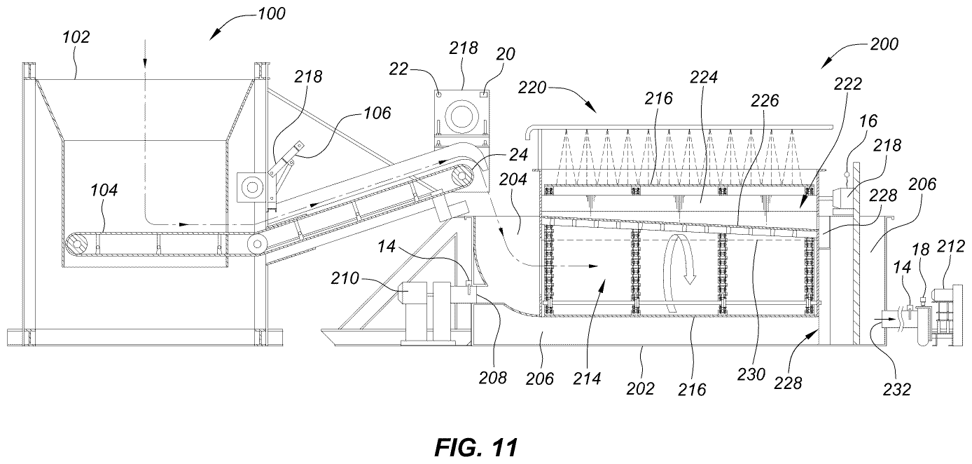

As illustrated in FIGS. 10-12, the rate control component may include the motor 218 responsive to commands from the PLC and operatively connected to the strike-off plate 106 to regulate the volume sand exiting the feed hopper 102 from the conveyor belt 104 by raising or lowering the plate 106. The one or more rate control components may further include the motor 218 for the head pulley shaft 24 configured to control the speed of belt 104 shaft rotation in response to the commands from the PLC, as indicated in the embodiment depicted in FIG. 11. It is contemplated that the PLC may utilize multiple rate control components in combination to achieve the first predetermined rate as part of producing the desired composition of fracturing slurry.

Some embodiments of the second predetermined rate may comprise the clean rate (bpm). To produce a desired composition of fracturing slurry, the clean rate (bpm) may be achieved and maintained utilizing the plurality of sensors in communication with the PLC. In some embodiments, and as represented in FIG. 11, the flow meter 14 may be positioned in line with the intake pump 210 to measure the flow rate of water being pumped into the intake chamber 204 and communicate the real-time information to the PLC. As illustrated in FIGS. 10 and 12, in other embodiments, the flow meter 14 may also be positioned in line with the one or more discharge pumps 212 to measure the flow rate of the sand and water mixture from the kinetic screening assembly 214 exiting the one or more discharge openings 232. In some embodiments, as represented in FIG. 12, the check valve 246 may be positioned to prevent flowback of the sand and water mixture upon exiting the discharge opening 232 while other embodiments, as represented in FIG. 11, may not incorporate any check valve 246 upon exiting the discharge opening 232. In additional embodiments, the sonic water level sensor 16 may be positioned on the tank 202 to measure and communicate the water level 230 of the unit chamber 206 to the PLC, as shown in FIGS. 5-6B and 10-12. In some embodiments, as represented in FIGS. 11-12, unscreened sand and water filtered through the kinetic screening assembly 214 may collect debris and non-uniform sand particles in the screen 216. In cleaning the screen 216 with pressurized water or fluid, the spray component 220 may direct debris to the collection tray 224 and sloped channel 226 of the debris collection component 222 for discharge through the outlet 228. However, additional water from the spray component 220 may increase the water level 230 of the tank as may be monitored by the sonic water level sensor 16. The PLC may receive the real-time information communicated by the sensors and transmit commands to the intake pump 210 for execution, such as to increase or decrease pumping power (kW) of the one or more motors, to speed up or slow down pumping of water into the intake chamber 204.

In some embodiments, the third predetermined rate may comprise the predetermined pressure (psi) of the fracturing slurry pumped from the one or more discharge pumps 212 to the one or more frac pumps. The predetermined pressure (psi) of the fracturing slurry may be achieved or maintained by the plurality of sensors in communication with the PLC to produce a desired composition of fracturing slurry. As illustrated in FIGS. 10 and 12, one or more pressure transducers 18 may be positioned at rate monitoring points, including one or more discharge pumps 212, to measure and communicate the pressure (psi) of the fracturing slurry supplied to the frac pumps to the PLC. In response to the real-time information, the PLC may transmit commands to the discharge pumps 212 to increase or decrease pumping power (kW) of the one or more motors 218 by adjusting pump rates to achieve or maintain the predetermined pressure (psi) of the fracturing slurry. It is known in the art that frac pumps may be used to increase the pressure (psi) of fracturing slurry for direct injection into wellbores. Accordingly, maintaining the predetermined pressure (psi) of the fracturing slurry may be beneficial to increasing the lifespan of the frac pumps.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A modular system for creating fracturing slurry, comprising:
a sand delivery component to deliver sand at a first predetermined rate to a screening and blending tank system;
the screening and blending tank system comprising a tank and configured to:
receive sand into an intake chamber located inside the tank;
receive water at a second predetermined rate through an intake opening in the tank using an intake pump;
filter sand and water through a kinetic screening assembly located inside the tank and fluidly connected to the intake chamber, wherein the screening assembly comprises at least one screen having a plurality of perforations of a predetermined size to separate out debris and oversized particles;
clean debris and oversized particles from the kinetic screening assembly into a debris collection component operatively connected to the screening assembly using a spray component disposed above the kinetic screening assembly, wherein the debris collection component comprises a collection tray coupled to a sloped channel having an outlet that exits the tank for discharge of debris and oversized particles;
receive a mixture of filtered sand and water from the kinetic screening assembly into a unit chamber within the tank, the unit chamber having at least one discharge opening to dispense the sand and water mixture;
transport the sand and water mixture along an inline blending component using at least one discharge pump fluidly connected to the discharge opening to receive a variable chemical input, wherein the sand and water mixture blends with the variable chemical input to produce a fracturing slurry; and
output the fracturing slurry for use in hydraulic fracturing operations at a third predetermined rate maintained by the at least one discharge pump.

2. The system of claim 1, wherein the sand delivery component comprises a feed hopper assembly having a feeder conveyor belt to meter sand into the intake chamber at the first predetermined rate.

3. The system of claim 1, further comprising at least one sensor positioned on the system to transmit real-time information to at least one programmable logic controller (PLC), wherein the PLC maintains a desired composition of fracturing slurry in response to real-time information transmitted from the sensor.

4. The system of claim 1, wherein the first predetermined rate is maintained using at least one sensor in communication with at least one PLC.

5. The system of claim 1, wherein the second predetermined rate is maintained using at least one sensor in communication with at least one PLC.

6. The system of claim 1, wherein the third predetermined rate is maintained using at least one sensor in communication with at least one PLC.

7. The system of claim 1, wherein the unit chamber maintains a desired level of the sand and water mixture.

8. The system of claim 1, wherein the tank comprises an open-top rectangular tank having a rounded bottom.

9. The system of claim 1, wherein the intake opening is located near a bottom of the tank.

10. The system of claim 1, wherein the intake chamber includes a partition configured to direct sand from the sand delivery component into contact with water from the intake opening.

11. The system of claim 1, wherein the kinetic screening assembly comprises a vibratory shaker screen deck suspended above the screened and water mixture in the unit chamber.

12. The system of claim 1, wherein the spray component comprises a spray bar having a plurality of perforations or orifices configured to disperse pressurized fluids across a width of the screen.

13. The system of claim 1, wherein the debris collection component comprises a screen as a bottom of the sloped channel to drain captured liquid back into the unit chamber.

14. The system of claim 1, further comprising a check valve operatively connected to the discharge opening to prevent flowback toward the unit chamber.

15. The system of claim 1, wherein the inline blending component comprises a pipe section positioned between the discharge opening and the at least one discharge pump, the pipe section comprising threaded or flanged ports.

16. The system of claim 1, wherein the one or more discharge pumps comprises two discharge pumps for split stream operations.

17. A modular apparatus for creating fracturing slurry, comprising:
a tank configured to receive sand into an intake chamber at a first predetermined rate;
an intake pump fluidly connected to the tank through an intake opening, wherein the intake pump is configured to control a flow of water through said opening into the tank at a second predetermined rate;
a kinetic screening assembly located within the tank and fluidly connected to the intake chamber, comprising a screen having a plurality of perforations of a predetermined size to separate out debris and oversized particles, wherein the kinetic screening assembly is configured to filter sand from the intake chamber;
a spray component disposed above the kinetic screening assembly configured to clean debris and oversized particles from said screening assembly;
a debris collection component operatively connected to the screening assembly, the debris collection component having a collection tray coupled to a sloped channel with an outlet that exits the tank for discharge of debris and oversized particles;
a unit chamber located within the tank having at least one discharge opening to dispense a mixture of filtered sand and water received from the kinetic screening assembly;
an inline blending component fluidly connected to the discharge opening and at least one discharge pump, comprising one or more inlets to inject a variable chemical input into the sand and water mixture, wherein the sand and water mixture blends with the variable chemical input to produce a fracturing slurry; and
the at least one discharge pump, wherein the discharge pump is configured to output the fracturing slurry at a third predetermined rate.

18. The apparatus of claim 17, further comprising two discharge pumps to be utilized in a split-stream hydraulic fracturing operation.

19. The apparatus of claim 17, further comprising at least one sensor configured to transmit real-time information to at least one programmable logic controller (PLC), wherein the PLC maintains a desired composition of fracturing slurry in response to real-time information transmitted from the sensor.

20. The apparatus of claim 17, wherein the first predetermined rate is maintained using at least one sensor in communication with at least one PLC.

21. The apparatus of claim 17, wherein the second predetermined rate is maintained using at least one sensor in communication with at least one PLC.

22. The apparatus of claim 17, wherein the third predetermined rate is maintained using at least one sensor in communication with at least one PLC.

23. The apparatus of claim 17, wherein the unit chamber maintains a predetermined level of the sand and water mixture.

24. The apparatus of claim 17, wherein the tank comprises a liner to prevent corrosiveness of produced water.

25. The apparatus of claim 17, wherein the kinetic screening assembly comprises an oval tumbling screen.

26. The apparatus of claim 17, wherein the spray component comprises one or more spray head nozzles having defined spray patterns.

27. The apparatus of claim 17, wherein the debris collection component comprises the collection tray operatively mounted within the screening assembly at an apex of rotation and wherein the screen comprises one or more ledges or flights affixed to an inner surface configured to lift debris and oversized particles.

28. The apparatus of claim 17, wherein the outlet is configured to direct debris and oversized particles to a container coupled to the tank.

29. The apparatus of claim 17, wherein the inline blending component comprises a pipe joint having one or more inlets that are two inches in length for direct injection of the variable chemical input.

30. The apparatus of claim 17, wherein the apparatus is mounted on a skid, truck, or trailer.

31. A modular system for creating fracturing slurry, comprising:
a sand delivery component to deliver sand at a first predetermined rate to a screening and blending tank system, wherein the sand delivery component achieves the first predetermined rate in response to one or more signals from at least one programmable logic controller (PLC) in communication with a plurality of sensors;
the screening and blending tank system comprising a tank and configured to:
receive sand into an intake chamber located inside the tank;
receive water at a second predetermined rate through an intake opening in the tank using an intake pump, wherein the intake pump achieves the second predetermined rate in response to one or more signals from the PLC in communication with the plurality of sensors;
filter sand and water through a kinetic screening assembly located inside the tank and fluidly connected to the intake chamber, wherein the screening assembly comprises at least one screen having a plurality of perforations of a predetermined size to separate out debris and oversized particles;
clean debris and oversized particles from the kinetic screening assembly into a debris collection component operatively connected to the screening assembly using a spray component disposed above the kinetic screening assembly, wherein the debris collection component comprises a collection tray coupled to a sloped channel having an outlet that exits the tank for discharge of debris and oversized particles;
receive a mixture of filtered sand and water from the kinetic screening assembly into a unit chamber within the tank, the unit chamber having at least one discharge opening to dispense the sand and water mixture;
transport the sand and water mixture along an inline blending component using at least one discharge pump fluidly connected to the discharge opening to receive a variable chemical input, wherein the sand and water mixture blends with the variable chemical input to produce a desired composition of fracturing slurry; and
output the fracturing slurry for use in hydraulic fracturing operations at a third predetermined rate maintained by the at least one discharge pump, wherein the discharge pump achieves the third predetermined rate in response to one or more signals from the PLC in communication with the plurality of sensors.

32. The system of claim 31, wherein the plurality of sensors are positioned at one or more rate monitoring points to transmit real-time information to the PLC.

33. The system of claim 31, wherein the PLC further comprises a data van or a control station.

34. The system of claim 31, wherein the plurality of sensors comprise a volumetric sensor positioned at the sand delivery component.

35. The system of claim 31, wherein the plurality of sensors comprise a moisture sensor configured to measure a moisture content of sand delivered to the intake chamber.

36. The system of claim 31, wherein the plurality of sensors comprise a flow meter positioned in line with the intake pump to monitor a flow rate of water.

37. The system of claim 31, wherein the plurality of sensors comprise a sonic water level sensor positioned on the tank to measure a water level of the unit chamber.

38. The system of claim 31, wherein the plurality of sensors comprise one or more pressure transducers positioned at the at least one discharge pump to measure a pressure of the fracturing slurry.

39. The system of claim 31, wherein the PLC transmits commands to a motor operatively connected to a strike-off plate to regulate a volume of sand delivered to the intake chamber.

40. The system of claim 31, wherein the PLC transmits commands to a motor for a head pulley shaft configured to control sand speed for the sand delivery component.

41. The system of claim 31, wherein a data van displays real-time information received by the PLC, including sand speed, sand concentration, clean rate, and slurry pressure.
